(19) United States
(12) Patent Application Publication
(10) Pub. No.: US 2003/0027885 A1
(43) Pub. Date: Feb. 6, 2003

(54) Photo-cross-linkable polymers, method of producing a cross-linked polymer, cross-linked polymer, and cross-linked polymer coating

(76) Inventors: Marcus Halik, Erlangen (DE); Klaus Lowack, Erlangen (DE); Recai Sezi, Rottenbach (DE); Andreas Walter, Egloffstein (DE)

Correspondence Address: LERNER AND GREENBERG, P.A., Post Office Box 2480, Hollywood, FL, 33022-2480, US

(21) Appl. No.: 10/187,017

(22) Filed: Jul. 1, 2002

(30) Foreign Application Priority Data
Jun. 29, 2001 (DE) 101 31 536.8

(51) Int. Cl. C08J 3/28; C08G 73/00; C08G 6/00; C08G 4/00; C08G 10/00; C08G 12/00; C08G 64/00

(52) U.S. Cl. 522/164; 528/367; 528/220; 528/370; 522/163; 522/162

(57) ABSTRACT

The novel photo-cross-linkable polymers are suitable as coating materials. The photo-cross-linkable polymers contain a biphenylene unit, which can be dimerized by exposure. Attached to the biphenyl unit are side chains of a polymer with a high temperature resistance and a high chemical stability. Through exposure, the biphenylene units dimerize, whereby the polymers are spatially cross-linked.

### BACKGROUND OF THE INVENTION

Field of the Invention

The present invention relates to photo-cross-linkable polymers and to cross-linked polymers obtained from the photo-cross-linkable polymers. The polymers exhibit a high mechanical stability and temperature resistance.

In the microelectronics industry, the auto industry, and the space industry, polymers with a high temperature resistance are needed as protection and as isolation layers. For example, such polymers can be utilized in multi-chip modules or memory and logic chips as a dielectric between a chip and a metallization plane or between two metal planes of the chip. In the automotive and aerospace industries, thermostable polymers are employed as weatherproof protective layers, for example. The polymers are stabilized by cross-linking for the purpose of improving the thermal resistance and the chemical and mechanical stability of the polymer materials. The cross-linking reaction can be triggered by heat or irradiation with light of a suitable wavelength.

Photo-chemically cross-linkable polymers are described in U.S. Pat. Nos. 3,817,876; 4,230,817; and 3,933,746.

These polymer materials exhibit thermostability characteristics that are not quite satisfactory.

In order to be able to generate thin polymer films such as those required in the field of microelectronics, the polymers—that is to say, their precursors—must exhibit good solubility in organic-solvents. Furthermore, they must possess good film formation characteristics, so that they can be processed by cost-effective spinning, immersion, or brushing techniques. The polymers must also exhibit good insulation characteristics, as well as a high thermal and chemical stability. In addition, the polymer material must exhibit good adhesion to substrates such as silicon, silicon oxide, silicon nitride, titanium nitride, tantalum nitride, glass or metals. Surfaces consisting of these materials emerge during the production of microchips and are coated with polymer materials.

### SUMMARY OF THE INVENTION

It is accordingly an object of the invention to provide photo-cross-linkable polymers that are suitable a coating materials, which overcomes the above-mentioned disadvantages of the heretofore-known devices and methods of this general type and provides for a photo-cross-linkable polymer that exhibits good solubility in organic solvents and good film formation characteristics, so that thin polymer films generated, and which can be cross-linked by subsequent exposure so as to yield cross-linked polymers with a high thermal stability, a high mechanical stressability, and good adhesion to a substrate.

With the foregoing and other objects in view there is provided, in accordance with the invention, a photo-cross-linkable polymer according to Formula I:

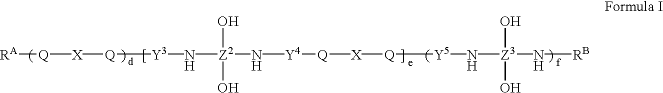

where R^{A} stands for:

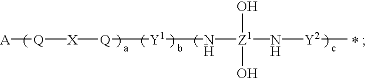

and R^{B} stands for:

*(Y⁶)_{g}(Q-X-Q)ₕA;

and where the following symbols are defined as follows, independently of one another:

A: a hydrogen atom, a heteroatom whose free valences are saturated by hydrogen atoms, or a single-bond residue, which can include up to 30 carbon atoms and one or more heteroatoms;

Q: *—O—*, *—S—*, or *—NH—*;

X: a double-bond residue including one or more repeating units, whereby X can include between 1 and 500 repeating units;

Y¹ to Y⁶: respectively independent double-bond residues with up to 50 carbon atoms and one or more heteroatoms, whereby Y¹ to Y⁶ comprises at least two carbonyl groups via which Y¹ to Y⁶ is bound to Q or to the NH group which is bound to the Z¹ to Z³ group, whereby at least the Y² groups are formed by a structural unit according to Formula II:

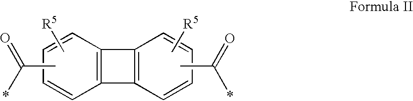

where R⁵ is a hydrogen atom or a single-bond residue with up to 15 carbon atoms which can also include one or more heteroatoms;

Z¹ to Z²: a quadruple-bond residue with up to 80 carbon atoms which includes two pairs of vicinal bonds to neighboring oxygen and nitrogen coming from a six-membered aromatic ring or a five- or six-membered heteroaromatic ring belonging to the Z¹ to Z³ group, whereby the bond pairs can come from the same ring or different rings.

a: 0 or 1; whereby if a=0 and b=1, then A=—OR^{x} or —NR^{x}₂, whereby R^{x} can be hydrogen or a single-bond residue with up to 20 carbon atoms irrespective of one another; and if a=1 then b=1;

b: 0 or 1, whereby if b=0, then a=0;

c: an integer between 1 and 100;

d: 0 or 1;

e: an integer between 0 and 20;

f: an integer between 0 and 100;

g: 0 or 1, whereby if g=0, then h=0;

h: 0 or 1, whereby if h=O and g=1, then A=—OR^{x} or —NR^{x}₂; and if h=1, then g=1.

The photo-cross-linkable polymers according to Formula I dissolve well in many organic solvents, such as cyclohexone, γ-butyrolactone, N-methylpyrrolidone, diethylene glycol, mono- and diethyl ethers, and ethyl acetate. The materials have good film formation characteristics and can be processed into a thin film by spinning, for example.

The photo-cross-linkable polymer contains two reactive groups by means of which the characteristics of the cross-linked polymers can be influenced.

First, the photo-cross-linkable polymer includes hydroxyamide groups, which cyclize into benzoxazole upon dehydration given heating. The thermal cyclization is represented the following way:

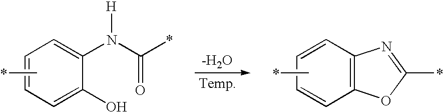

With the cyclization into oxazole, the polymer already acquires a high thermal stability and a high chemical stability.

The photo-cross-linkable polymer also acquires photodimerizing biphenylene units, which can be dimerized by irradiation with light with a wavelength between 230 and 600 nm, preferably 365 nm. The reaction is represented as follows:

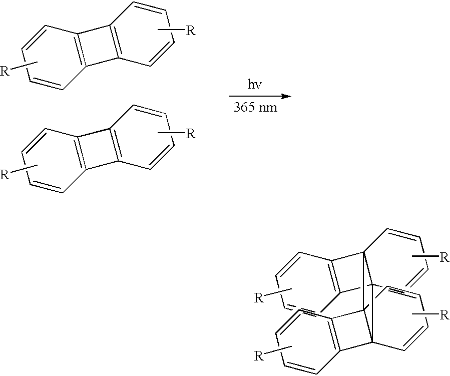

The three-dimensional cross-linking further enhances the thermal resistance of the cross-linked polymer and its stability with respect to chemical and thermal influences. The material characteristics of the cross-linked polymer, such as its thermal and chemical stability, dielectricity constant or adhesion to a substrate, can be influenced by way of the order in which the individual steps are carried out for the cyclization into the benzoxazole group and for the cross-linking of the polymer chains by exposure. In purely thermal techniques, the individual steps are determined by the thermal activation energy of the individual processes, and therefore they cannot be modified for a polymer system without further ado.

The polymer chains R which are bound to the biphenylene unit correspond to portions of the inventive photo-cross-linkable polymers which attach to both sides of the biphenylene unit. Depending on the position and structure of the polymer, the residues R can be identical or different.

They advantageously consist of temperature resistant units, for instance polybenzoxazoles or polyimides, provided that the photo-cross-linking process is carried out after the cyclization of the hydroxyamide groups, and consist of the corresponding prestages when the cyclization is carried out after the photo-cross-linking. The photo-cross-linkable biphenylene unit is suitably integrated into these temperature-resistant units. The cross-linking of the polymer chains is achieved independent of thermally initiated processes such as the cyclization into oxazole and can therefore be performed in various processing stages. For example, the cross-linking can occur below or above the cyclization temperature. The degree of cross-linking is variably adjustable by way of the corresponding exposure dose and is detectable by fluorescence spectroscopy. If thermally labile constituents whose decomposition temperature is optimally above the cyclization temperature are worked into the photo-cross-linkable polymer, it is possible to stabilize homogenously distributed cavities in the polymer matrix by performing photochemical cross-linking and thermal cyclization with subsequent decomposition of the thermally labile constituents. These cavities reduce the density of the material while high thermal, chemical, and mechanical stabilities are preserved, and so improve the isolation characteristics of the cross-linked polymer.

The side chains of the polymer, which are bound to the biphenylene unit, make a very wide structural variety possible. The characteristics of the polymers can be optimized for a specific application purpose, such as for an isolation layer, by suitably selecting the groups A, Q, X, Y¹ to Y⁶ and Z¹ to Z³ which are present in the polymers. The group Z¹ to Z³ can comprise up to 80 carbon atoms, for example. The group Z¹ to Z³ contains at least one 6-member aromatic or at least one 5- or 6-member heteroaromatic ring. From this ring protrudes at least one pair of vicinal bonds, to which an oxygen and a nitrogen are bound, respectively. The group Z¹ to z³ comprises at least two pairs of such bonds. The bond pairs can come from the same ring or from different rings. The rings can be further substituted, for instance in that additional aromatic or heteroaromatic rings are condensed on. Cycloalkyl rings can also be condensed on, whereby these can also carry substitutes such as alkyl groups, ketone groups, or halogen atoms. The aromatic or heteroaromatic groups can also be connected via single bonds or alkylene chains, or via heteroatomic groups such as an ether group or a sulfide group.

Preferred structural units for Z¹ to Z³ are selected from the following group:

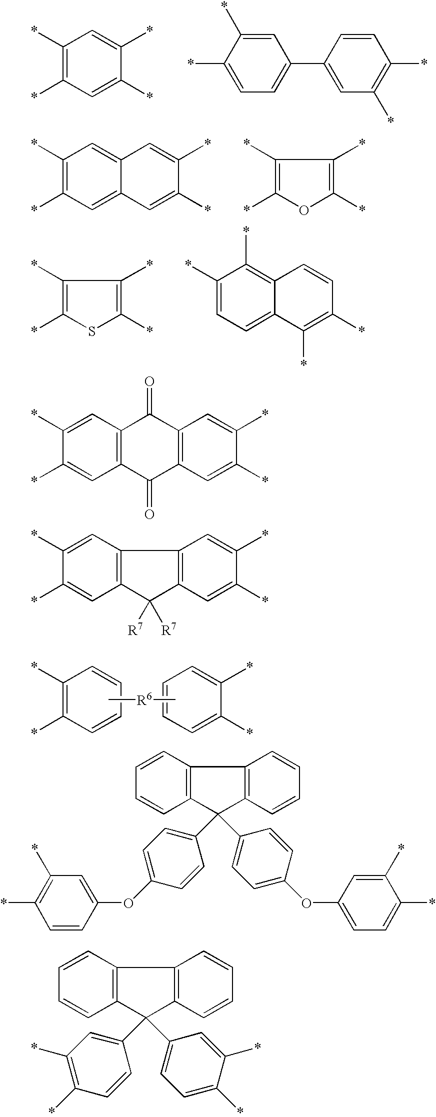

whereby

R⁶: is a single bond, a double-bond residue with up to 30 carbon atoms which can also comprise one or more heteroatoms, or a double-bond heteroatomic group;

R⁷: is an alkyl group with up to 10 carbon atoms, an aryl group with up to 20 carbon atoms, or an aralkyl group with up to 20 carbon atoms, whereby the hydrogen in these groups can also be partly or wholly replaced by fluorine.

Within the photo-cross-linkable polymer, the groups Z¹ to Z³ can be identical or different.

Heteroatoms are atoms which are not carbon or hydrogen, particularly oxygen, nitrogen, sulfur, silicon, and, as single-bond heteroatoms, halogen atoms as well.

The characteristics of the photo-cross-linkable polymers can also be influenced through the structural units of the group Y¹ to Y⁶. To this end, Y¹ to Y⁶ can also comprise other structural units besides the photodimerizing biphenylene unit. As with the group Z¹ to Z³, a wide structural variety is possible here as well. Either aromatic or heteroaromatic rings can form a group Y¹ to Y⁶, whereby the rings can be condensed to one another or joined via single bonding, i.e. via alkyl or alkylene chains. The carbonyl group in the group Y¹ to Y⁶ can be bound directly to an aromatic or heteroaromatic ring or via an alkylene, alkenylene, or alkinylene residue. A connection can also be realized via heteroatomic groups such as an ether bond, a thioether bond, or a carbonyl group. Y¹ to Y⁶ can also be formed from an alkylene residue carrying terminal carbonyl groups, via which the bond to the neighboring nitrogen or the Q group is formed. The alkylene chain can carry heteroatoms in the chain or in lateral positions, and can also be substituted by additional substitutes such as alkyl groups or halogen atoms.

Besides the structural unit according to Formula II, additional structural units are preferably also provided for the group Y¹to Y⁶ in the photo-cross-linkable polymer, which are selected from the following group:

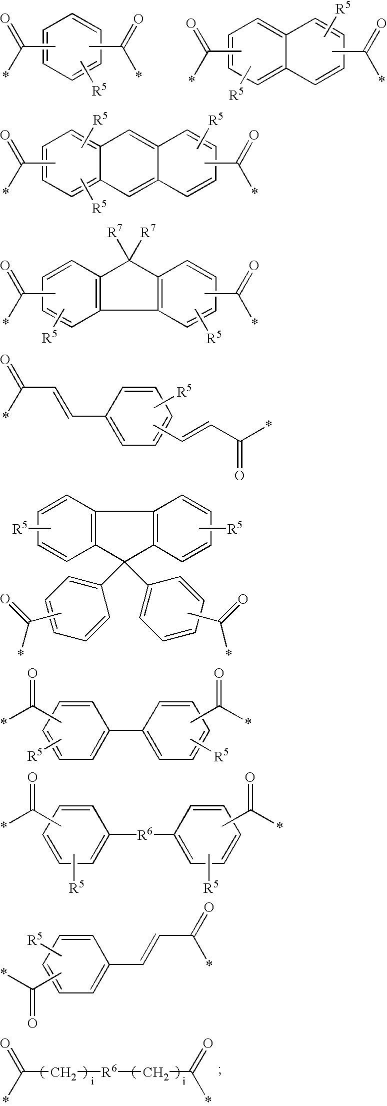

whereby R⁵, R⁶, and R⁷ are defined as in claims 1 and 2; and

i is an integer between 1 and 10, or, when R⁶ is a single bonding or a —CH₂— group, an integer between 0 and 10.

In the above described structural units of the groups Z¹ to Z³ and Y¹ to Y⁶, R⁵ is preferably selected from the following group:

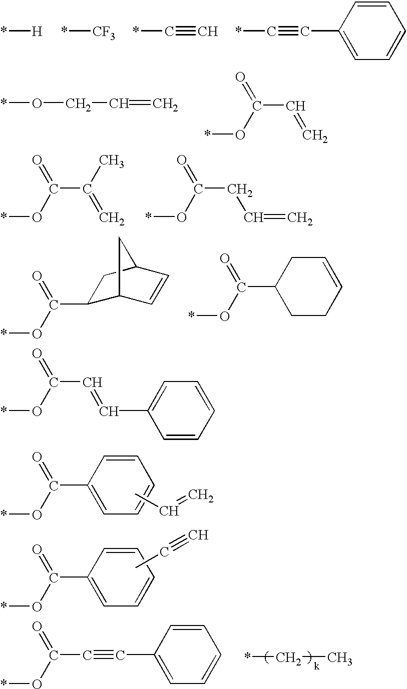

where k is an integer between 0 and 10.

R⁶ is preferably selected from the following group:

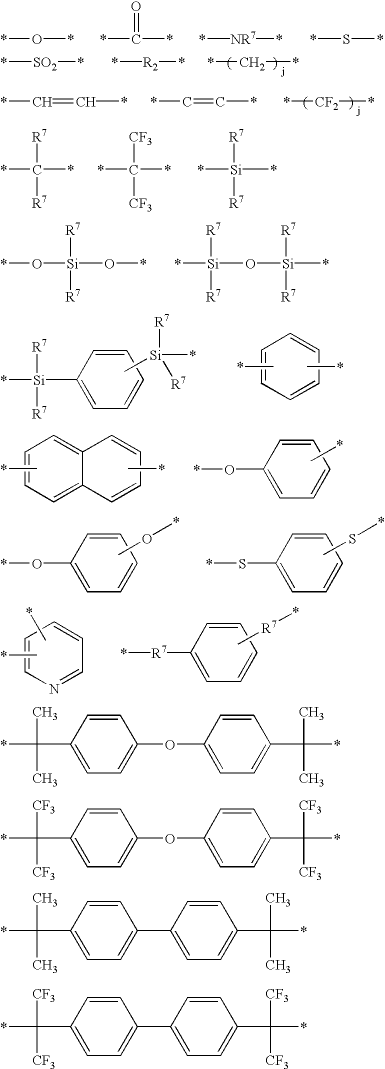

whereby j is an integer between 1 and 10.

R⁷ is preferably selected from the following group:

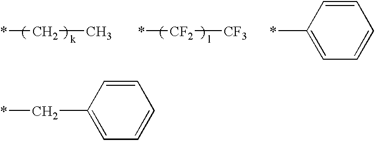

whereby k is defined as above (0≦k≦10), and 1 is an integer between 0 and 10.

The x group in the photo-cross-linkable polymer according to Formula I can comprise between 1 and 500 repeating units. The repeating units can be connected by ester bonds, amide bonds, imino bonds, or ether bonds.

x is preferably selected from the following group:

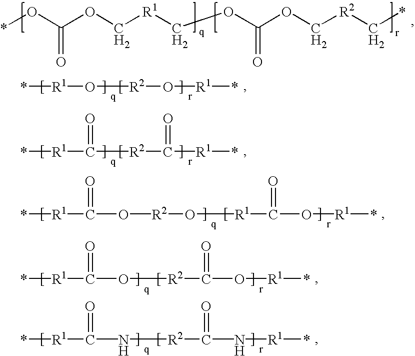

whereby

q is an integer between 0 and 100;

r can be an integer between 0 and 100, on condition that r and q cannot both be 0;

R¹ and R² can be equal or different, and are a single bond, a linear or branched alkylene residue, or a cycloalkylene residue with up to 20 carbon atoms, an arylene residue with up to 20 carbon atoms, or an aralkylene residue with up to 30 carbon atoms.

R¹ and R² are preferably selected from the following group:

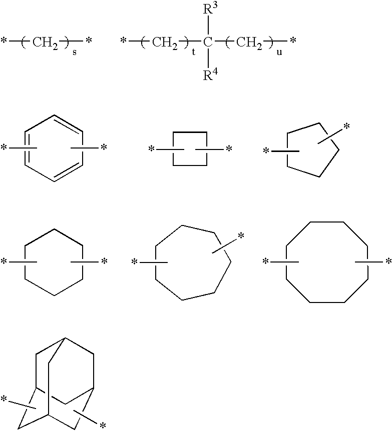

whereby s is an integer between 0 and 20;

t,u is an integer between 0 and 20; and

R³, R⁴ are each a hydrogen atom or an alkyl residue with 1 to 11 carbon atoms, independently of one another.

In the photo-cross-linkable polymer according to Formula I, A forms the terminal group of the side chain. In the simplest case, it can be a hydrogen or hydroxy group. The terminal amino group of a Z group can also carry an alkyl, an alkenyl, an alkinyl, or an aromatic or heteroaromatic residue.

In the photo-cross-linkable polymer according to Formula I, if a=1 and/or h=1, then A is preferably selected from the following group:

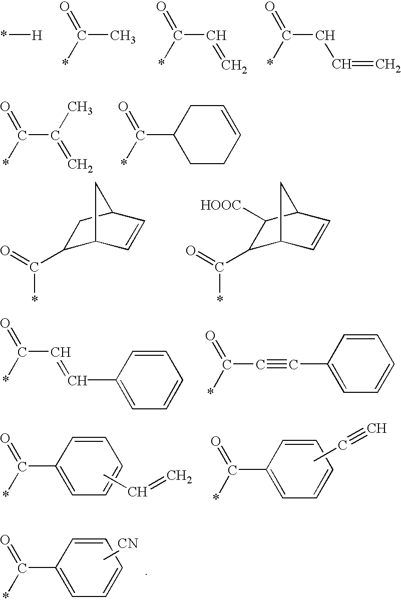

As described above, cross-linked polymers with valuable characteristics can be produced from the above photo-cross-linkable polymer. Therefore, the subject matter of the invention also includes a cross-linked polymer which is obtained in that a photo-cross-linkable polymer as described above:

(a) is subjected to heat treatment whereby the hydroxyamide group of the photo-cross-linkable polymers is cyclized into oxazole upon dehydration; and

(b) the Y¹ to Y⁶ groups, which include a structural unit according to Formula II, are cross-linked by irradiation with light with a wavelength between 230 and 600 nm;

whereby the steps (a) and (b) can be performed in any order or at the same time.

In a preferred embodiment, the cross-linked polymer includes cavities which are uniformly distributed in its volume. The cavities reduce the specific weight of the cross-linked polymers, thereby improving the isolating characteristics. The cross-linked polymer has a high thermal stability of more than 450° C. It is also characterized by a good chemical stability. For example, it is insoluble in N-methylpyrrolidone to at least 100° C. Furthermore, the cross-linked polymer also exhibits good adhesion on substrates like silicon oxide, silicon nitride, titanium nitride, tantalum nitride, glass, or metals, and it also exhibits good isolating characteristics with a dielectric constant Dk on the order of 2.6.

The subject matter of the invention also includes a method for producing a cross-linked polymer film whereby a solution of an above described photo-cross-linkable polymer is created in a solvent; the solution is deposited on a substrate, and then the solvent is evaporated, so that a film of the photo-cross-linkable polymer is obtained, and the film

(a) undergoes heat treatment, whereby the hydroxyamide group of the photo-cross-linkable polymer is cyclized into oxazole upon dehydration; and

(b) the Y groups with a structural unit according to Formula II are cross-linked by irradiation with light;

whereby steps (a) and (b) can be carried out simultaneously or in any order.

A thermally labile additive can be added to the photo-cross-linkable polymer. During the curing of the cross-linked polymer, the thermally labile additives decompose, and homogenously distributed cavities form in the cross-linked polymer.

Although the invention is illustrated and described herein as embodied in photo-cross-linkable polymers as coating materials, it is nevertheless not intended to be limited to the details shown, since various modifications and structural changes may be made therein without departing from the spirit of the invention and within the scope and range of equivalents of the claims.

The implementation of the invention, however, together with additional objects and advantages thereof will be best understood from the following description of specific embodiments when read in connection with the following examples.

### EXAMPLES

### Production of Photo-Cross-Linkable Polymers

Polymer 1

The following starting materials were used for producing Polymer 1:

9,9′-bis-(4-((3-hydroxy-4-amino)phenyloxy)phenyl)fluorene (Bisaminophenol 1)

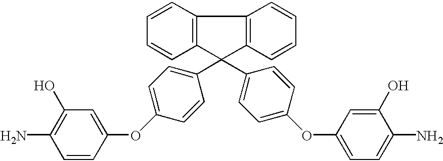

UC-Carb 100 (UBE Industries, Ltd)-(Bishydroxycarbonate 1)

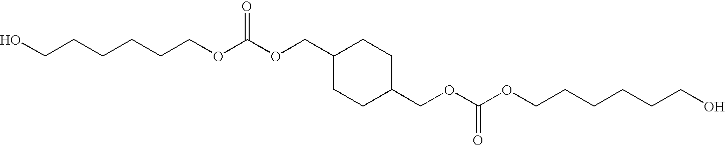

2,7-biphenylene dicarboxylic acid chloride

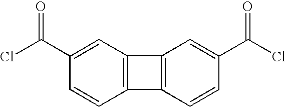

12.00 g (21.25 mmol) bisaminophenol 1 are dissolved in 100 ml distilled N-Methylpyrrolidone (NMP). A suspension of 7.06 g (25.5 mmol) 2,7-biphenylene-dicarboxylic acid dichloride in 50 ml. distilled γ-Butyrolactone (γ-BL) is dripped into this solution at 10° C. while stirring. This is stirred for 1 hour at 10° C. and then for an hour at 20° C. Next, a solution of 8.50 g (8.5 mmol) bishydroxycarbonate 1 in 60 ml. distilled NMP is added in at 10° C. The reaction solution is stirred an additional 1.5 hours at 10° C. and then 12 hours at 20° C. After being recooled to 10° C., the reaction mixture is mixed with 6.44 g (63.75 mmol) triethylamine (base 1) which is dissolved in 20 ml distilled NMP, and heated to room temperature.

In order to isolate the polymer, the reaction mixture is filtered, and the filtrate is dripped into 2500 ml 2-propanol. The precipitated polymer is extracted and washed twice in 2000 ml fully desalinated cold water and once in 2000 ml fully desalinated water at 80° C., and dried for 72 hours at 50° C./10 mbar.

Polymer 2

Starting Materials:

9,9′-bis-(4-((3-hydroxy-4-amino)phenyloxy)phenyl)fluorene-(bisaminophenol 1)

Poly(propylene glycol) bis (2-amino-propylether) MW-4000 2,7-biphenylene dicarboxylic acid dichloride

12.00 g (21.25 mmol) bisaminophenol 1 are dissolved in 100 ml distilled N-Methylpyrrolidone (NMP). A suspension of 6.44 g (23.25 mmol) 2,7-biphenylene-dicarboxylic acid dichloride in 50 ml. distilled γ-butyrolactone (γ-BL) is dripped into this solution at 10° C. while stirring. This is stirred at 10° C. for 1 hour and then at 20° C. for an hour. Next, a solution of 11.09 g (2.77 mmol) poly(propylene glycol) bis(2-amino-propylether) in 60 ml. distilled NMP is added in at 10° C. The reaction solution is stirred an additional 1.5 hours at 10° C. and then 12 hours at 20° C. After being recooled to 10° C., the reaction mixture is mixed with 5.87 g (58.12 mmol) triethylamine (base 1) in 20 ml distilled NMP, and heated to room temperature.

In order to isolate the polymer, the reaction mixture is filtered, and the filtrate is dripped into 2500 ml 2-propanol. The precipitated polymer is extracted and washed twice in 2000 ml fully desalinated cold water and once in 2000 ml fully desalinated water at 80° C., and dried for 72 hours at 50° C./10 mbar.

Polymer 3

Starting Materials:

2,2-bis-(3-amino-4-hydroxyphenyl)-hexafluoropropane-(bisaminophenol 2)

14.64 g (40 mmol) in 150 ml dist. NMP

2,7-biphenylene dicarboxylic acid dichloride

10.80 g (40 mmol) in 200 ml NMP

cis-S-norbornene-endo-2,3-dicarboxylic acid anhydride—(endcap 1)

0.13 g (0.8 mmol) in 25 ml γ-BL

pyridine—(base 2)—6.96 g (88 mmol) in 50 ml γ-BL

Polymer 3 is represented the same way as Polymer 1, with the exception that the endcap 1 and pyridine as base 2 is inserted 10 in place of the bishydroxycarbonate 1.

### Example 2

### Determination of the Thermostabilities

The polymers produced in Example 1 exhibit thermal stabilities >450° C. (TGA determination) and an isothermal mass loss of 0.3% per hour at 425° C. for 10 hours.

### Example 3

### Production of a Polymer Solution and Preparation of Layers.

The polymers produced in Example 1 dissolve well in solvents like NMP, γ-butyrolactone, tetrahydrofurane, cyclohexanone, cyclopentanone, and diethyleneglycol mono-methylether.

5 g of a polymer represented in Example 1 are dissolved in 20 g NMP (VLSI-Selectipur®). The dissolving process takes place on a vibrating apparatus. Next, the solution is pressure-filtered into a steamed test tube through a 0.2 μm filter. 2 ml of such a polymer solution are coated onto a 4″ silicon wafer by means of a centrifuge (2500 rpm, 20 s) and then dried on a hot plate for 4 minutes at 120° C. Next, the silicon wafer is tempered in an oven in an inert gas atmosphere (1 h at 280° C.—Cure I), whereby the cyclization into benzoxazole occurs. In a final tempering step (1 h at 400° C.—Cure II), the material is converted into its final form. The exposure step may optionally come after the drying or the tempering (Cure I).

### Example 4

### Exposure of a Polymer Layer

A polymer film (see Example 3) is irradiated with light with a wavelength of 365 nm using a commercial exposure device either after drying or after tempering (Cure I). The exposure dose is between 5 and 20 J/cm². The extent of the cross-linking can be determined by fluorescence measurement according to the decline of the fluorescence bands at 530 nm.

### Example 5

### Determination of the Adhesion on Various Substrates

a) Determining the Adhesion of Polymer 1 on a Titanium Layer

A 4″ silicon wafer is sputtered with a 50 nm titanium layer. Polymer 1, which consists of a 20% solution (solvent: γ-butyrolactone), is spun onto this wafer (5 s at 500 rpm and 25 s at 3500 rpm). After a short softbake for 1 minute at 120° C. on a hot plate, and exposure with 6 J/cm², a silicon chip which is 4×4 mm², whose surface has also been sputtered with 50 nm titanium, is pressed onto the polymer film with a force of 2N. Next, this stack is tempered in an oven in a nitrogen atmosphere for 1 hour at 280° C. and for 1 hour at 400° C. After cooling to room temperature, an adhesion test is performed by means of a shear tester (Dage series 400). The boundary surface first detached under a force of 2.0 kg/mm². This value is 24% higher than for a commercial polyimide that is used as a protective and isolating layer.

b) Determination of the Adhesion of Polymer 1 on a Tantalum Nitride Layer

A 4″ silicon wafer is sputtered with a 50-nm-thick tantalum nitride layer. As in Example 5.2, a layer of Polymer 1 is deposited onto this wafer and exposed, and a 4×4 mm² Si chip, likewise with a tantalum nitride surface, is pressed on as in Example 5.1. After the heating of the layer system at 400° C., the adhesion was determined by shear testers. Here, a shear force of 1.9 kg/mm² was needed to detach the boundary surface.

c) Determination of the Adhesion of Polymer 2 on Silicon Wafers After Thermal Stress Tests

As described in Example 5.1, Polymer 2 is spun onto a silicon wafer and processed, and a 4×4 mm² silicon chip is glued on. Next, this stack is thermally stressed 50 times at temperatures between −50° C. and 150° C. in a climatic test enclosure (Voetsch VT7004). Subsequent to this treatment, a shear test was conducted. Here, a force of 1.8 kg/mm² was needed in order to separate the boundary surfaces. This value is 19% higher than for the commercial polyimide after this treatment.

### Example 6

Determination of the Chemical Stability

A wafer is processed as described in Example 3. After cooling to room temperature, the coated wafer is heated to 80° C. for 5 hours in NMP. The wafer is then dried in a vacuum at 200° C. for 60 minutes, and the mass difference is determined. The mass loss equals:

POLYMER 1: 0.4%

POLYMER 2: 0.2%

POLYMER 3: 0.5%

1. A photo-cross-linkable polymer of the general formula 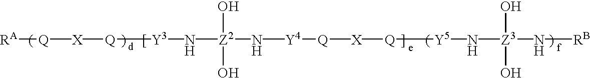
where R^{A} stands for: 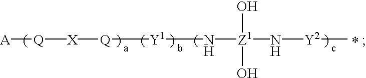
and R^{B} stands for:
*(Y⁶)_{g}(Q-X-Q)ₕA;
and the following definitions apply, independently of one another:
A: a hydrogen atom, a heteroatom with free valences saturated by hydrogen atoms, or a single-bonded residue that may comprise up to 30 carbon atoms and one or more heteroatoms;
Q: *—O—*, *—S—*, or *—NH—*;
X: a double-bonded residue which comprises one or more repeating units, whereby X may comprise between 1 and 500 of the repeating units;
Y¹ to Y⁶: independently of one another, a double-bonded residue with up to 50 carbon atoms, whereby Y¹ to Y⁶ comprises at least two carbonyl groups via which Y¹ to Y⁶ is bonded to Q or to the NH group that is bonded to the Z group, whereby at least the Y² groups are formed by a structural unit according to the following formula: 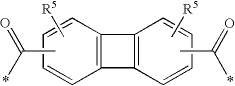
where R⁵ is a hydrogen atom or a single-bonded residue with up to 15 carbon atoms, and optionally with one or more heteroatoms;
Z¹ to Z³: independently of one another, a quadruple-bonded residue with up to 80 carbon atoms, which comprises two pairs of vicinal bonds to neighboring oxygen and nitrogen which come from a six-membered aromatic or a five- or six-membered heteroaromatic ring belonging to the Z group, whereby the bond pairs may emerge from the same ring or different rings;
a: 0 or 1, whereby if a=0 and b=1, then A=—OR^{x} or —NR^{x}₂, whereby R^{x} can be hydrogen or a single-bonded residue with up to 20 carbon atoms, independently of one another; and if a=1, then b=1;
b: 0 or 1, whereby if b=0, then a=0;
c: an integer between 1 and 100;
d: 0 or 1;
e: an integer between 0 and 20;
f: an integer between 0 and 100;
g: 0 or 1, whereby if g=0, then h=0;
h: 0 or 1, whereby if h=0 and g=1, then A=—OR^{x} or —NR^{x}₂; and if h=1, then g=1.

2. The photo-cross-linkable polymer according to claim 1, wherein Z¹ to Z³ is selected from the group consisting of: 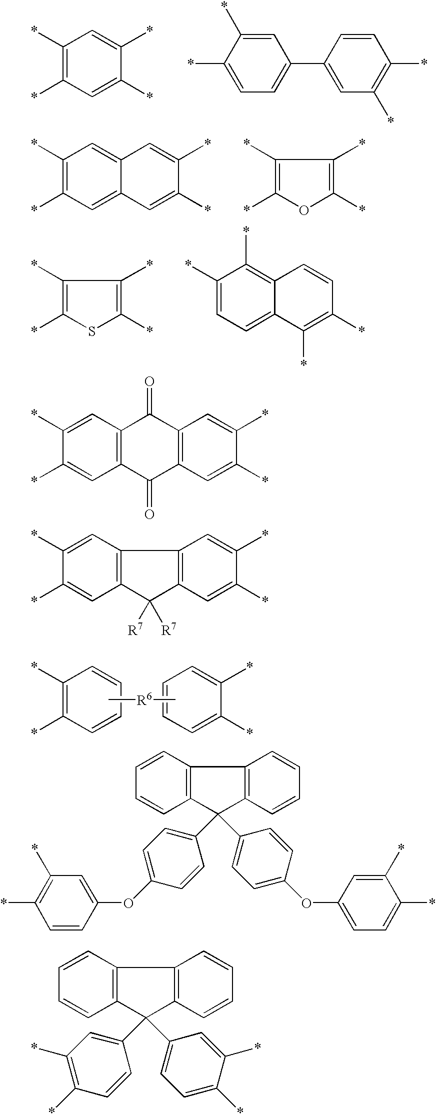
wherein:
R⁶: is a single bond, a double-bonded residue with up to 30 carbon atoms with one of more optional heteroatoms, or a double-bonded heteroatomic group;
R⁷: an alkyl group with up to 10 carbon atoms, an aryl group with up to 20 carbon atoms, or an aralkyl group with up to 20 carbon atoms, wherein the hydrogen in these groups may be wholly or partly replaced by fluorine.

3. The photo-cross-linkable polymer according to claim 1, wherein additional structural units are provided for the groups Y¹ to Y⁶, which are selected from the group consisting of: 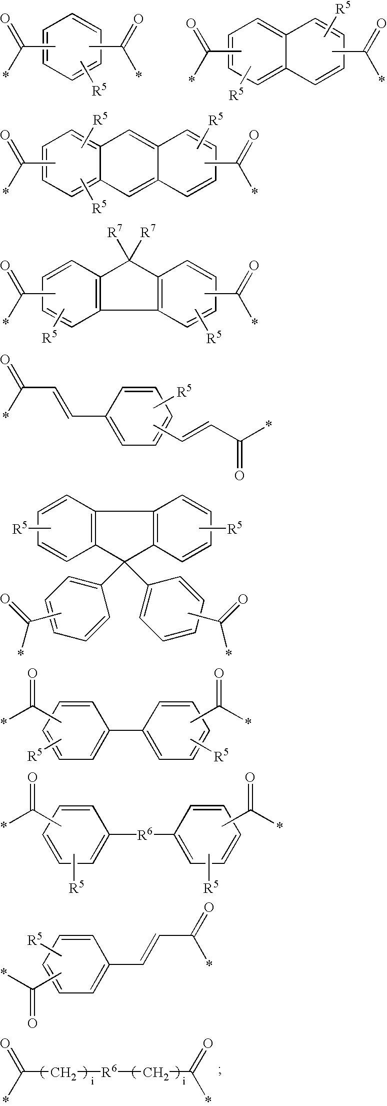
wherein:
R⁶ is a single bond, a double-bonded residue with up to 30 carbon atoms with one of more optional heteroatoms, or a double-bonded heteroatomic group;
R⁷ is an alkyl group with up to 10 carbon atoms, an aryl group with up to 20 carbon atoms, or an aralkyl group with up to 20 carbon atoms, wherein the hydrogen in these groups may be wholly or partly replaced by fluorine; and
i is an integer between 1 and 10, or, if R⁶ is one of a single-bond and a —CH₂— group, then i is an integer between 0 and 10.

4. The photo-cross-linkable polymer according to claim 1, wherein R⁵ is selected from the group consisting of: 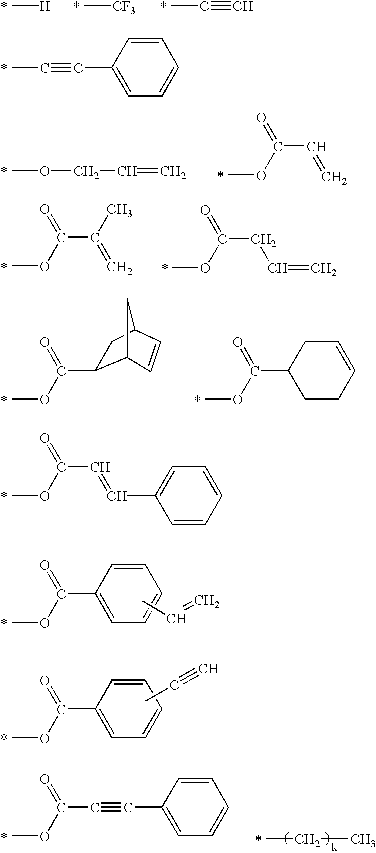
where k is an integer between 0 and 10.

5. The photo-cross-linkable polymer according to claim 2, where R⁶ is selected from the group consisting of: 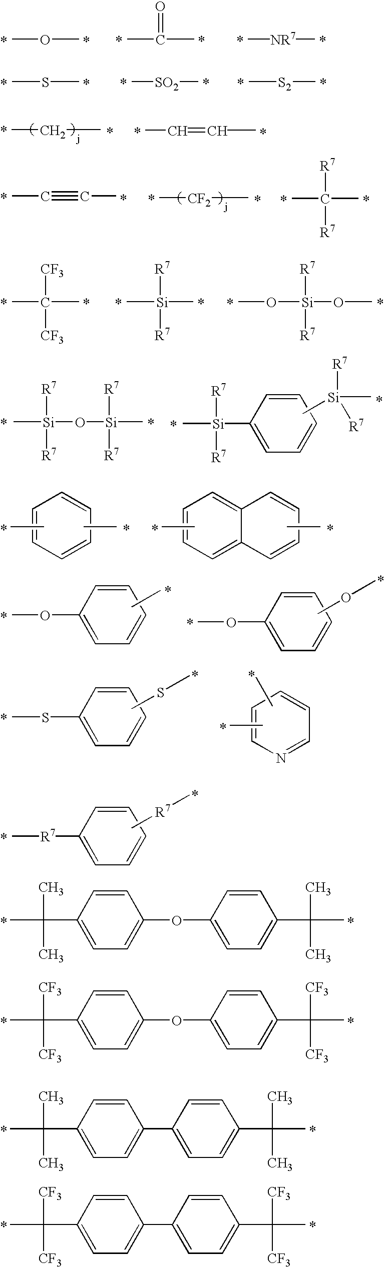
where j is an integer between 1 and 10.

6. The photo-cross-linkable polymer according to claim 2, wherein R⁷ is selected from the group consisting of: 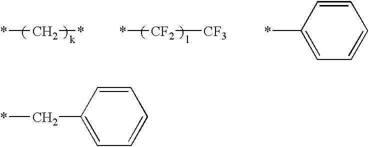
where k is an integer between 0 and 10, and l is an integer between 0 and 10.

7. The photo-cross-linkable polymer according to claim 1, wherein X is selected from the group consisting of: 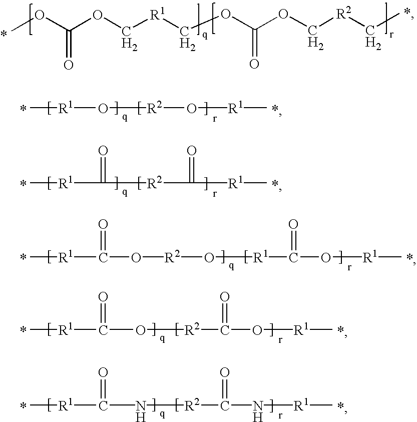
where
q is an integer between 0 and 100;
r is an integer between 0 and 100, with a proviso that r and q cannot both be 0; and
R¹ and R² may be identical or different and a single bond, a linear or branched alkylene residue, or a cycloalkylene residue with up to 20 carbon atoms, an arylene residue with up to 20 carbon atoms, or an aralkylene residue with up to 30 carbon atoms.

8. The photo-cross-linkable polymer according to claim 7, wherein R¹ and R² are selected from the group consisting of: 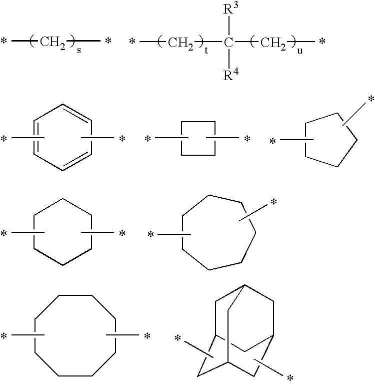
where
s is an integer between 0 and 20;
t and u each is an integer between 0 and 20; and
R³ and R⁴ each is a hydrogen atom or an alkyl residue with 1 to 11 carbon atoms, independently of one another.

9. The photo-cross-linkable polymer according to claim 1, wherein, if at least one of the following is true: a=1 and h=1, then A is selected from the group consisting of:

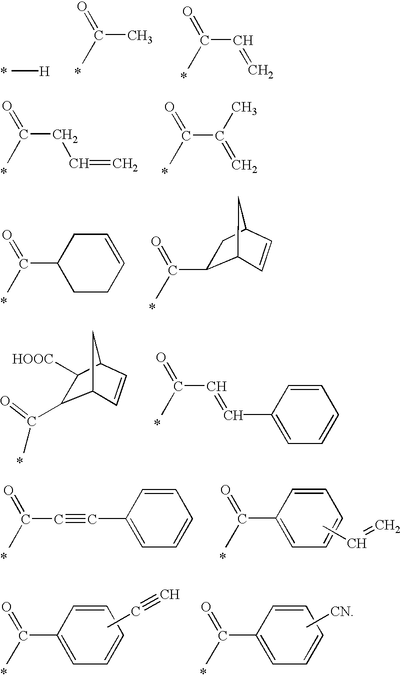

10. The photo-cross-linkable polymer according to claim 1, wherein, if any pair of conditions selected from the group of a=0 and b=1, and h=0 and g=1, then A is selected from the group consisting of:

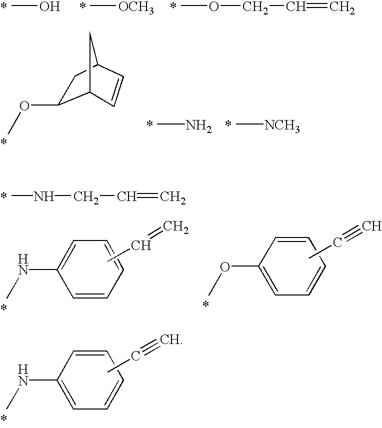

11. A method of forming a cross-linked polymer, which comprises:
providing a photo-cross-linkable polymer according to claim 1;
heat-treating the polymer to cyclize the hydroxy amide group of the photo-cross-linkable polymer into oxazole on dehydration; and
cross-linking the Y¹ to Y⁶ groups, which include a structural unit according to 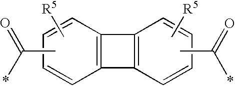
by irradiating with light having a wavelength of 230 nm to 600 nm;
wherein the heat-treating and cross-linking steps may be performed in any order or simultaneously.

12. A cross-linked polymer, comprising:
the photo-cross-linkable polymer according to claim 1 subjected to a heat-treatment in which the hydroxy amide group of the photo-cross-linkable polymer is cyclized to oxazole with dehydration; and
wherein the Y¹ to Y⁶ groups, which include a structural unit according to 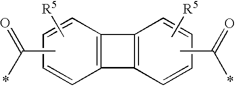
were cross-linked by irradiation with light having a wavelength of 230 nm to 600 nm;
and wherein the heat-treating and cross-linking steps may have been performed in any order or concurrently.

13. The cross-linked polymer according to claim 12, whereby said cross-linked polymer has cavities formed therein uniformly distributed in a volume thereof.

14. A method of producing a cross-linked polymer, which comprises:
preparing a solution of the photo-cross-linkable polymer according to claim 1 in a solvent;
depositing the solution on a substrate, evaporating the solvent, to form a film of the photo-cross-linkable polymer; and
subjecting the film to a heat treatment, whereby the hydroxyamide group of the photo-cross-linkable polymer is cyclized into oxazole and dehydrated; and
cross-linking the Y-groups having a structural unit according to the formula 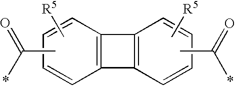
by irradiation with light having a wavelength between 230 nm to 600 nm;
and wherein the heat-treatment and the cross-linking step may be performed in any order or concurrently.

15. The method according to claim 14, which further comprises adding a thermolabile additive to the photo-cross-linkable polymer.
